(19) United States
(12) Patent Application Publication
(10) Pub. No.: US 2016/0042156 A1
(43) Pub. Date: Feb. 11, 2016

(54) METHOD AND SYSTEM FOR DRUG DESIGN

(71) Applicant: THE ARIZONA BOARD OF REGENTS ON BEHALF OF THE UNIVERSITY OF ARIZONA, Tucson, AZ (US)

(72) Inventors: Jon T. Njardarson, Tucson, AZ (US); David T. Smith, Tucson, AZ (US); Edon Vitaku, Tucson, AZ (US)

(21) Appl. No.: 14/820,577

(22) Filed: Aug. 7, 2015

Related U.S. Application Data
(60) Provisional application No. 62/034,741, filed on Aug. 7, 2014.
(60) Provisional application No. 62/038,083, filed on Aug. 15, 2014.

(51) Int. Cl. G06F 19/00; G06F 17/30; G06Q 30/00

(52) U.S. Cl. CPC G06F 19/366; G06Q 30/018; G06F 17/30528

(57) ABSTRACT

The present invention provides a method for conducting a drug discovery research by identifying a lead candidate based solely on drugs that have been approved for a clinical use by an agency who has the authority to approve a drug for clinical use in mammal. The method uses a cheminformatics database. The present invention also provides a method and system for analyzing chemical drugs that have been approved for clinical use.

### CROSS-REFERENCE TO RELATED APPLICATIONS

This application claims the priority benefit of U.S. Provisional Application Nos. 62/034,741, filed Aug. 7, 2014, and 62/038,083, filed Aug. 15, 2014, all of which are incorporated herein by reference in their entirety.

### FIELD OF THE INVENTION

The present invention relates to a method and system for drug design. The present invention also relates to a method and system for analyzing chemical compounds such as drugs and identifying a suitable lead compound for a drug design by using a database that consists essentially of a list of drugs that have been approved for clinical use by an agency that has a legal authority to approve drugs for clinical use in mammals, in particular humans.

### BACKGROUND OF THE INVENTION

Cheminformatics, which involves the study or analysis of chemical databases, can be used as a tool in the development of new materials and pharmaceuticals by aiding in the selection of starting points for drug, material, and/or product development. Drug informatics is the application of cheminformatics specifically to drugs and pharmaceutical compounds. Drug informations is useful as a guide and/or a starting point for drug development.

While a variety of chemical databases are available, both commercial and public, no particular analysis of chemical compounds that are useful in therapeutics has been published. In particular, no analysis of an agency (e.g., Food and Drug Administration or “FDA”) approved drugs have been conducted to date.

Since drug informatics can significantly reduce the cost and time in discoverying new drugs, there is a need for a method and system for analyzing various databases to determine common structural features (e.g., chemical substructure, substituents, etc.) that results in biological activities.

### SUMMARY OF THE INVENTION

Images of molecular architectures serve as effective catalysts that provoke serendipitous discovery. Establishing a detailed knowledge of common pharmaceutical structural motifs can reveal areas for the development of new synthetic methodologies.⁶ Some aspects of the invention provides a method for developing a drug candidate or conducting a research based on the analysis of database of known and/or a governmental agency (e.g., U.S. Food and Drug Administration or FDA) approved drugs. Such an analysis can reveal a variety of key elements, such as core chemical structure, substituent patterns, substituent(s), etc., that are common or can be exploited in new drug discovery.

In one particular embodiment, a database that can be used in identifying suitable structural features, substituent patterns, and/or type of substituent(s) for treatment of a particular clinical indication. Such a database can be used in identifying a possible structure activity relationship (SAR), identification of a lead compound, suitable substituent(s), substituent patterns, etc. The database can also be used to conduct a research in discovering a new class of compounds (e.g., different core chemical structure, substituent pattern, and/or substituent(s)) for treatment of a particular clinical condition.

One particular aspect of the invention provides a method for conducting a drug discovery research, said method comprising:
(a) searching a database to identify a lead drug candidate,
(b) synthesizing a plurality of derivatives of said lead drug candidate;
(c) analyzing a bioactivity of each of said plurality of derivatives of said lead drug candidate; and
(d) identifying a drug candidate based on the analysis of said bioactivity of each of said plurality of drug candidate derivatives.

In some embodiments, the step of searching said database comprises:
(i) obtaining a list of drug candidates and relative occurrence of drug candidate hits based on an inquiry parameter;
(ii) obtaining a subset of relative occurrences of one or more of the other parameters of the database; and
(iii) identifying said lead drug candidate based on the analysis of said step (i), (ii) or a combination thereof.

Yet in another embodiment, the database consists essentially of a list of drugs in a searchable data objects, wherein said drug is approved for a clinical use by an agency having an approval authority for using said drug in a mammal. The searchable data objects consists essentially of chemical structure of a drug, wherein said chemical structure comprises a core structure, substituent, a functional group, or a combination thereof; and clinical indication approved for said drug by said agency.

Still in another embodiment, the agency that approves the drug for clinical use is U.S. Food and Drug Administration, World Health Organization (WHO), a European Union Agency having an approval authority for using said drug in a mammal, or a combination thereof.

In other embodiments, the database is generated by (i) obtaining unprocessed data associated with a chemical compound from said agency; (ii) parsing said unprocessed data into a plurality of data objects based on a categorization associated with each of the data objects; (iii) identifying and associating additional information with at least one of the data objects; and (iv) storing the data objects in entries within a data structure, wherein said data structure is searchable based on one or more of the data objects. Within these embodiments, in some instances at least one of the data objects comprises the presence of a nitrogen atom, sulfur atom, fluorine atom, or a combination thereof. In other instances, the step of parsing the unprocessed data comprises identifying heteroatoms in said drug, identifying a presence of a ring system in said drug, a molecular weight of said drug, approved use of clinical conditions for said drug, or a combination thereof. In some cases, the step of identifying heteroatoms in said drug comprises identifying the number of each heteroatoms in said drug. Still in other cases, the step of identifying the presence of the ring system in said drug comprises identifying a ring size of said drug, identifying a number of ring system in said drug, or a combination thereof.

The data objects is often standardized such that the search inquiry will result in a consistent result.

Another aspect of the invention provides a database for identifying a lead drug candidate consisting essentially of (a) a list of drugs in a searchable data objects, wherein said drug is approved for a clinical use by an agency having an approval authority for using said drug in a mammal; (b) a searchable chemical structure object of said drugs, wherein said searchable chemical structure object comprises a core structure, a substituent, a functional group, or a combination thereof; and (c) a clinical indication approved for said drug by said agency.

In some embodiments, the database is stored remotely. Alternatively, the database can be locally stored or can be a stand-alone database.

Still another aspect of the invention provides a system for searching for a lead drug candidate. The system typically comprises an input device adapted for allowing a user to enter an inquiry data object; a database described herein; and a display unit for displaying a search result to said user. It should be appreciated that the display unit can be an electronic monitor or a printer that outputs the results in a printed format. The system typically includes a central processing unit (e.g., in the form of a computer) that is operatively connected to the input device and which can access the database. The database can be stored remotely or locally.

### BRIEF DESCRIPTION OF THE DRAWINGS

FIG. 1 shows breakdown of US FDA Approved Drugs.

FIG. 2 shows top Twenty Five Most Frequent Nitrogen Heterocycles in US FDA Approved Drugs.

FIG. 3 shows Top four Most Common Four Membered Nitrogen Heterocycles

FIG. 4 shows Structural Variations of Approved Cephem Pharmaceuticals.

FIG. 5 shows Structural Variations of Approved Penam Pharmaceuticals.

FIG. 6 shows Top five Most Common Five Membered Aromatic Nitrogen Heterocycles.

FIG. 7 shows Thiazole Containing Pharmaceuticals

FIG. 8 shows Imidazole Containing Pharmaceuticals.

FIG. 9 shows Indole Containing Pharmaceuticals.

FIG. 10 shows Top five Most Common Six Membered Aromatic Nitrogen Heterocycles.

FIG. 11 shows Pharmaceuticals Containing Pyridines.

FIG. 12 shows Pharmaceuticals Containing Pyrimidines.

FIG. 13 shows Pharmaceuticals Containing Piperidines.

FIG. 14 shows Top Four Most Common Bridged Bicyclic Nitrogen Heterocycles.

FIG. 15 shows Tropane Derived Pharmaceuticals.

FIG. 16 shows Morphinan Derived Pharmaceuticals.

### DETAILED DESCRIPTION OF THE INVENTION

While many databases for chemical structures are available, each and everyone of the conventional chemical databases suffer one or more of the various shortcomings such as, overly broad set of information (or data objects), inability to search subset of structures, functional groups, heteroatoms, etc., and/or approved clinical indication(s), frequency or relative abundance of a particular heteroatom, functional group, core structure, etc. Moreover, some chemical structures in the database are inaccurate for one reason or another.

Such shortcomings render database not particularly useful in identifying a lead drug candidate. The term “drug” as used herein refers to a chemical compound that is approved by an agency to be used in therapeutics. The “agency” refers to any governmental agency or a legal entity that is authorized by a government or a member state (e.g., European Union and World Health Organization (WHO), etc.) to grant authority to use a chemical compound for a therapeutic use in a mammal.

One of the key features of the database of the invention is that it contains drugs that have been approved by an agency that has an authority to allow use of a chemical compound (e.g., drug) in a therapeutic use. In addition, the database of the invention includes a searchable chemical structure database object. Exemplary searchable chemical structure database objects include, but are not limited to, core structure, heteroatoms (e.g., S, F, and N), ring structures, stereochemistry of a substituent, etc.

There are many data format for a chemical compounds such as MDL® mol files, MDL® SD files, ChemDraw® file, ISIS® SKC files, text file, etc. Any one of these file formats can be used in methods and systems of the invention as long as one can search the data objects using a graphic user face input and/or text input.

The database of the invention consists essentially of (1) a chemical structure, as described above; and (2) clinical indication for which the drug has been approved for use by the agency. Such a database significantly reduces the amount of time required to conduct an inquiry based search for a lead drug candidate. The database can be remotely located (e.g., can be accessed via online) or it can be located locally (e.g., on a hard drive, flash drive, compact disc, computer memory, etc.) which does not require an online access, or it can be located within a particular set of network system (e.g., on a company server, or a separate database maintained by a company or an organization, etc.).

Another key feature of the invention is the results of a search inquiry is provided with a relative occurrence of a particular data object. For example, when one enters an inquiry for a nitrogen heterocyclic ring system, the results shows not only the various nitrogen heterocyclic ring systems, but also the relative abundance of each nitrogen heterocyclic ring systems in the database. This allows, what type of nitrogen heterocyclic ring system has been most often been approved for a therapeutic use. Such an information is important as one can start from the most occurring data object as a starting point or start from the least occurring data object as a starting point in order to avoid any possible intellectual property issues.

One can also search the database based on a clinical indication. For example, a search for a cardiovascular disease, or a cancer treatment drug, or a cholesterol drug can yield a diverse chemical structure whose output can be further divided into a relative occurrence of core structures, substituents, and/or heteroatoms (e.g., S, O, N, P, etc.). Such a result then provides the common core structure that are most effective in a particular therapeutic use.

Various aspects of the invention will now be further described with reference to analysis of the structural diversity, substitution patterns and frequency of drugs from U.S. FDA approved pharmaceuticals. However, it should be appreciated that the scope of the invention is not limited to such analysis as one skilled in the art can readily recognize that the methods and systems disclosed herein are applicable to any other chemical databases that are available.

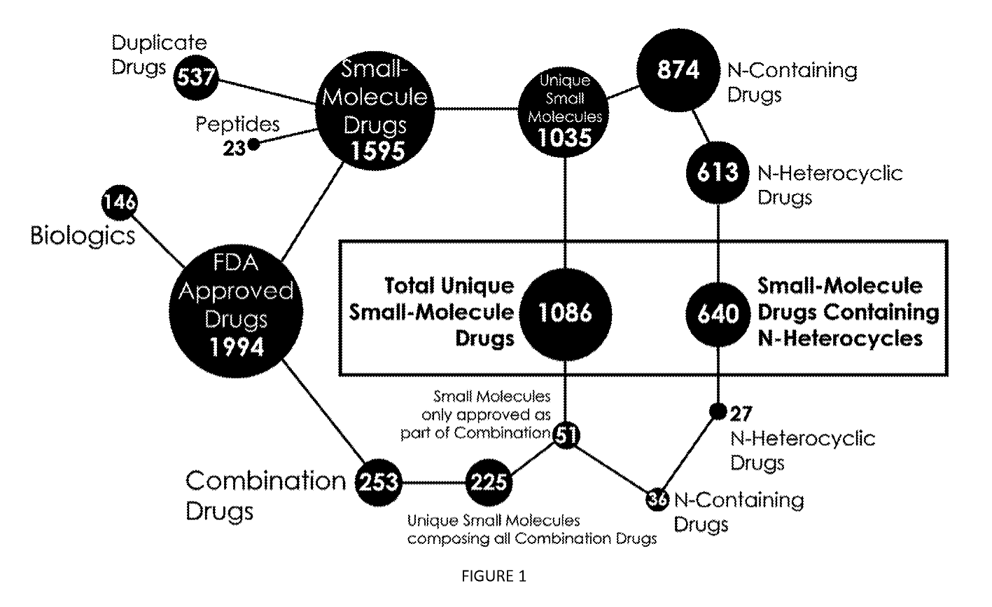

Nitrogen heterocycles are among the most significant structural components of pharmaceuticals. Analysis of database of U.S. FDA approved drugs reveals that 59% of unique small molecule drugs contain a nitrogen heterocycle. Disclosed herein is the drug informatics analysis result using the methods and systems of the invention. In particular, the top 25 most commonly utilized nitrogen heterocycles found in pharmaceuticals are disclosed as an illustration of applicability of drug informatics method and system of the invention. In this particular embodiment, the analysis is divided into seven sections (i.e., 3/4, 5, 6, and 7/8-membered ring system as well as fused, bridged bicyclic and macrocyclic nitrogen heterocycles) all of which reveal the top nitrogen heterocyclic structures and their relative impact within each section. See FIG. 1. For the most frequently used nitrogen heterocycles, the search result also provides detailed substitution patterns, core structures and unusual or rare structures.

The results of a search inquiry can also be organized according to disease categories. Methods and systems of the invention can be used as research and/or teaching tools that exploit the graphical language of organic chemistry. Design format of data analysis disclosed herein presents topics such as structural patterns, frequency of atoms and substructures while also providing the type of chemical structure derivatives of approved pharmaceuticals that can be used as a starting point of drug discovery. Furthermore, the format of database presented herein allows such analyses to be conducted as a function of time (e.g., date of US FDA approval) and the disease condition (or clinical condition) for which the drugs were approved. One particular data analysis of the invention involves the frequency, distribution and diversity of sulfur and fluorine containing pharmaceuticals. In this perspective, one of the objectives is to comprehensively analyze the nitrogen heterocycle composition, frequency and structural diversity among U.S. FDA approved small molecule drug architectures. Further analysis includes more detailed analysis of several sections based on nitrogen heterocyclic ring size.

A quick cursory glance at any one of the analysis results of pharmaceutical drugs reveals that nitrogen heterocycles are common drug fragments. This initial quick survey shows that it would be of broad interest to gather more information and exact details about this important dataset. For example, one of the analyses involves impact of nitrogen heterocycle drug architectures. Such analysis can be used to determine which nitrogen heterocyles are most commonly used as a drug or are approved by U.S. FDA. The analysis also shows how many different nitrogen heterocyclic scaffolds are represented, among other things. Furthermore, given the general interest in developing new useful methods for making nitrogen heterocycles such an in-depth analysis can aid research programs by highlighting which nitrogen heterocycles had been incorporated into approved pharmaceuticals and their relative success.

Database used in one particular embodiment of this invention contained 1994 pharmaceutical compounds or drugs (i.e., U.S. FDA approved drugs). See FIG. 1. One of the best measure of the success of nitrogen heterocycles is to focus exclusively on structurally unique small molecule drugs. Referring to FIG. 1, subtracting biologics (146, 7%), combination drugs (253, 13%), peptides (23, 1%) and removing any drug duplications (537, 27%) resulted in 1035 unique small molecule for analysis. This number is slightly larger (1086) because among combination drugs there are 51 unique small molecule drugs that were never approved on their own but only as part of a combination. Of these 51 drugs, 36 contain a nitrogen atom, and importantly for analysis, 27 contain a nitrogen heterocycle thus taking the total of unique drugs containing at least one nitrogen heterocycle from 613 to 640. Of these unique small molecule pharmaceuticals, a total of 910 (84%) contain at least one nitrogen atom and 640 (59%) contain at least one nitrogen heterocycle. These are incredibly high percentages, far surpassing the impact numbers for sulfur and fluorine. Interestingly, the average number of nitrogen atoms per drug is 2.3N/drug for all the small molecule drugs while it is 35% higher in those containing a nitrogen heterocycle (3.1N/drug).

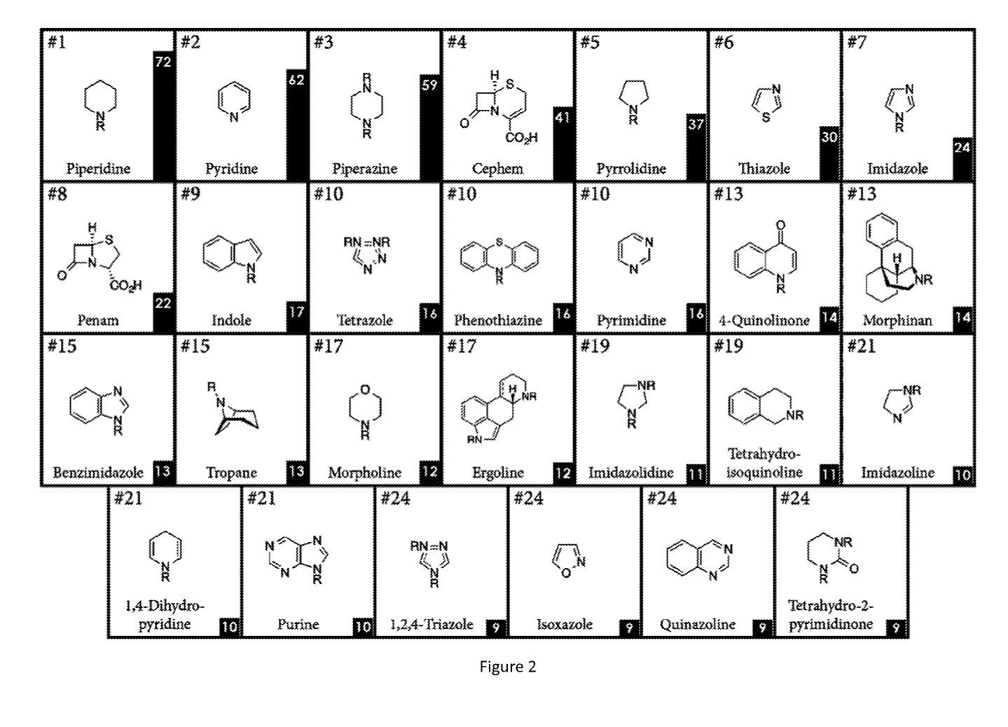

Having compiled and categorized all of the 640 nitrogen heterocycle containing pharmaceuticals (i.e., drugs), data was analyzed to determine which ones are most common in approved drugs. Shown in FIG. 2 are the results of this analysis, which displays the 25 most common nitrogen heterocycles in order of decreasing frequency represented by a solid colored bar, wherein the color serves the purpose of highlighting the various ring system classes. In first place, appearing in a total of 72 unique small molecule drugs is piperidine. Two additional six membered nitrogen heterocycles occupy the second and the third most occurrence position, with pyridine being the second most occurring (62 drugs) followed closely by piperazine (59 drugs). Significantly behind the top three is the β-lactam cephem core being part of 41 approved drugs. Not far behind is pyrrolidine (37 drugs). Two more five membered nitrogen heterocycles, thiazole and imidazole occur next most frequently. After which, penam, indole, phenothiazine and pyrimidine are the most occurring nitrogen heterocycles with about equal representation.

It is interesting to note that four of the eleven most commonly used nitrogen heterocycles also contain a sulfur atom (cephem, thiazole, phenothiazine and penam). The remaining nitrogen heterocycles in the top 25 are about equally represented in terms of the number of drugs they are found in, but remarkable for their amazing structural diversity with representation ranging from simple five membered rings to complex natural motifs (morphinan, ergoline, tropane, cephem and penam). Only two of 12^{th}-25^{th} ranked nitrogen heterocycles contain another heteroatom than nitrogen (morpholine and isoxazole).

The breakdown with respect to number of nitrogen atoms within these twenty-five heterocycles is such that fifteen (60%) contain a single nitrogen atom, nine contain two (36%) with purine (4%) containing four nitrogen atoms. Thirteen (52%) of the top 25 are represented by a single ring, which are evenly represented between six (7/13) and five (6/13) membered rings. Aromatic rings are common structural components of many approved pharmaceuticals. Nitrogen heterocycles are no exception, with 36% of the top twenty-five being aromatic. Interestingly, only four nitrogen heterocycles from this top list contain a carbonyl group as part of their primary ring systems (cephem, penam, quinolinone, and tetrahydropyrimidinone).

To provide a more in-depth insight into the diversity, distribution and significance of the various nitrogen heterocycles, discussions and analyses are broken into seven sections: 1) Three and four membered rings, 2) five membered rings, 3) six membered rings, 4) fused rings, 5) seven and eight membered rings, 6) bicyclic rings and 7) macro- and metallocycles. As is evident, the relative impact of the various nitrogen heterocyclic classes varies significantly, with six membered rings (59%) most frequently utilized followed by five (39%) membered and fused (14%) rings. Given the importance of five and six membered rings, analysis and coverage for these two sections were further split into aromatic and non-aromatic nitrogen heterocyclic sub-sections. This additional breakdown is significant as the result reveals a remarkable difference between the two ring sizes, with 62% of five membered nitrogen heterocycles being aromatic while only 28% of six membered rings are aromatic.

The fused ring section focuses on ring systems that contain more than one nitrogen heterocycle fused together. By including this section, a decision as to what ring category those systems should belong to is avoided. The final section, macro- and metallocycles, captures the rest of the nitrogen heterocyclic motifs while also being an interesting reminder of the fascinating organic architectures that have been approved as drugs.

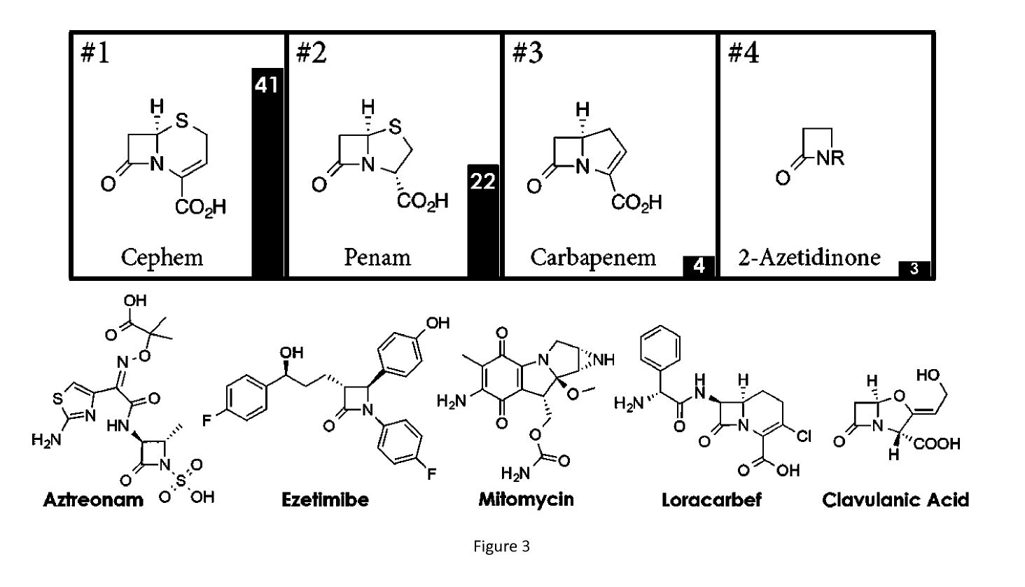

This section involves discussion of nitrogen heterocycles that are part of three or four membered rings. The top four in this sub-class are shown in FIG. 3. With the exception of a single aziridine containing drug (mitomycin C), the nitrogen heterocycles in this section are all β-lactams, of which 95% are fused to another ring with the nitrogen atom shared and only three are not fused. The pharmaceutical architectures that are featured in this section are least diverse in terms of diseases the drugs represented are used to treat. Case in point, all but the cholesterol lowering agent zetia of the β-lactam drugs are antibiotics or used in combination with antibiotics. The β-lactams belong to four structural families, whose central cores primarily differ in terms of the ring fused to the β-lactam (cephems, penams or carbapenems) or if such a ring fusion is absent (monobactams). The cephems (cephalosporin family) and the penams (penicillin family) are the most common central cores, representing 55% and 30% of the approved β-lactam antibiotics, respectively. Next with much less representation (5%) are the carbapenems wherein the sulfur atom of the penam core has been replaced with a carbon atom and the unsaturation that is part of the cephem core has been added. Three single atom permutations of these successful cores (penams and cephems) have also made it into approved drugs, with the sulfur atom replaced by either an oxygen or carbon atom as exemplified in FIG. 3 by clavulanic acid and lorabid, respectively.

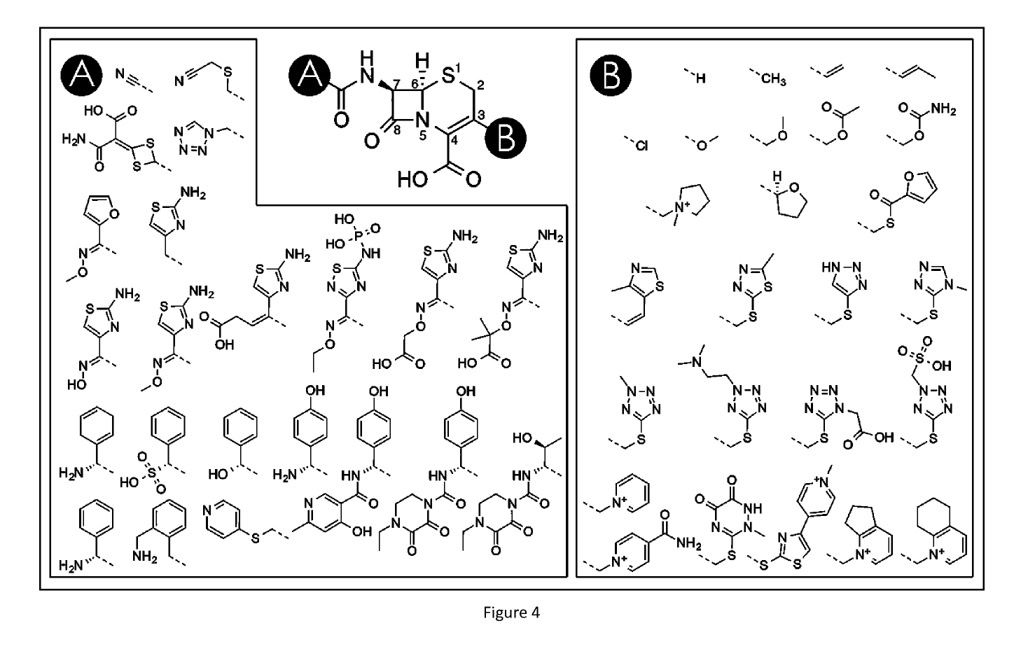

With the cephalosporins (cephems) being the β-lactam sub-family with most approved members (41), it was decided to take a closer look at their structural diversity. One of the goals was to learn what positions on the cephem core were most commonly altered and what types of groups were added to these positions (FIG. 4). Data analysis revealed that two main positions are altered on the cephem core, the nitrogen amide acyl group (labeled A) and the β-olefin position of the carboxylate group (labeled B). The acyl amide group occurs in 26 different structural permutations among the 41 US FDA approved cephalosporin drugs, while the β-position of the carboxylate is represented by 21 different substitution variations. These two positions are as far apart from each other as possible on the common cephem core. Both positions commonly contain a heterocycle, with 65% and 62% of the acyl amide and β-olefin positions respectively being substituted with a heterocycle. These side chains tend to contain a sulfur atom with eleven of the permutations in each chain having at least one sulfur atom. For the acyl amide chain, the sulfur atom is usually part of a thiazole (64%) while for the β-olefin positions the sulfur atom is most likely to be an arylated sulfide (73%). A significant number of the β-olefin substitution permutations contain short acyclic chains (35%), which is far less common (10%) for the acyl amide group. With respect to polar groups the two cephem positions are substituted very differently. Almost all (81%) of the acyl amide side chains contain a free polar group (hydroxyl, acid, amide, phosphonic acid or an amine), which is less common for the β-olefin side-chain (19%). In contrast, for the β-olefin side-chain, the frequent presence of a cyclic ammonium group (19%) is unique. Of the many interesting substituents found in these side-chains, none is more remarkable than the densely decorated four membered dithietane heterocycle found in cefotetan. Cefotetan is also notable for the fact that it is one of only handful of cephem drugs also containing an additional substituent at C7. The cephalosporin family of β-lactam drugs is even more diverse than shown FIG. 4, with close to twenty other structurally unique cephalosporin drugs having been approved internationally by agencies other than the US FDA.

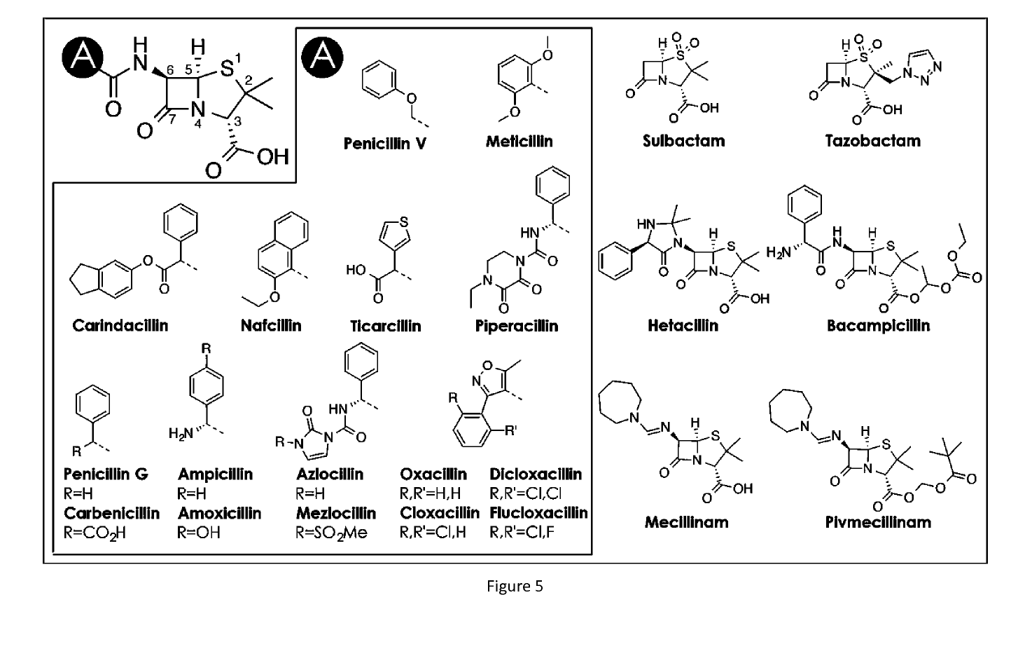

The penams are the second largest family of β-lactam antibiotics, with twenty-two unique US FDA approved structures (FIG. 5). Majority of the penams (73%) only contain structural variations at the 6-amino acyl group, of which 38% are directly connected to an aryl group, and 50% are attached to a benzylic amino or carboxylate functionality. Sulbactam and tazobactam are unique among this family as they both lack the 6-amino group while also having the common cyclic sulfide group in a higher oxidation state (sulfone). Furthermore, sulbactam and tazobactam are also notable for the fact that they are the only penams that are only approved as part of a combination, but not as stand along drugs. Mecillinam and ampicillin are noteworthy for having carboxylate pro-drug variants being approved for both (pivmecillinam and bacampicillin), wherein the carboxylate group in the 3-position has been derivatized with labile acetal tethers. Mecillinam is also structurally unique for the presence of a 6-amino group being part of an imine instead of an amide. Finally, hetacillin is also a pro-drug of ampicillin, containing labile cyclic diamino ketal (imidazolidinone) functionality.

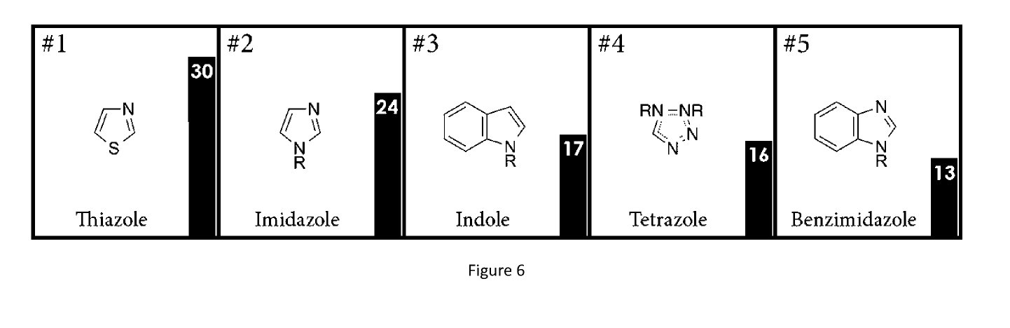

Five membered aromatic nitrogen heterocycles are important structures that are part of many approved pharmaceuticals. The top five most commonly used heterocycles in this class are presented in FIG. 6 along with numbers showing how many different unique pharmaceutical structures each is a part of. These top five aromatic heterocycles appear in a total of 93 drugs, which is 9% of the total number of unique US FDA approved small molecule (1086). Interestingly, only indole contains a single heteroatom with the other four having additional nitrogen (imidazole and benzimidazole), oxygen (oxazole) or sulfur (thiazole) atoms. Of these four heterocycles, only isoxazole has the two heteroatoms connected to each other while the other three have them separated by a carbon atom.

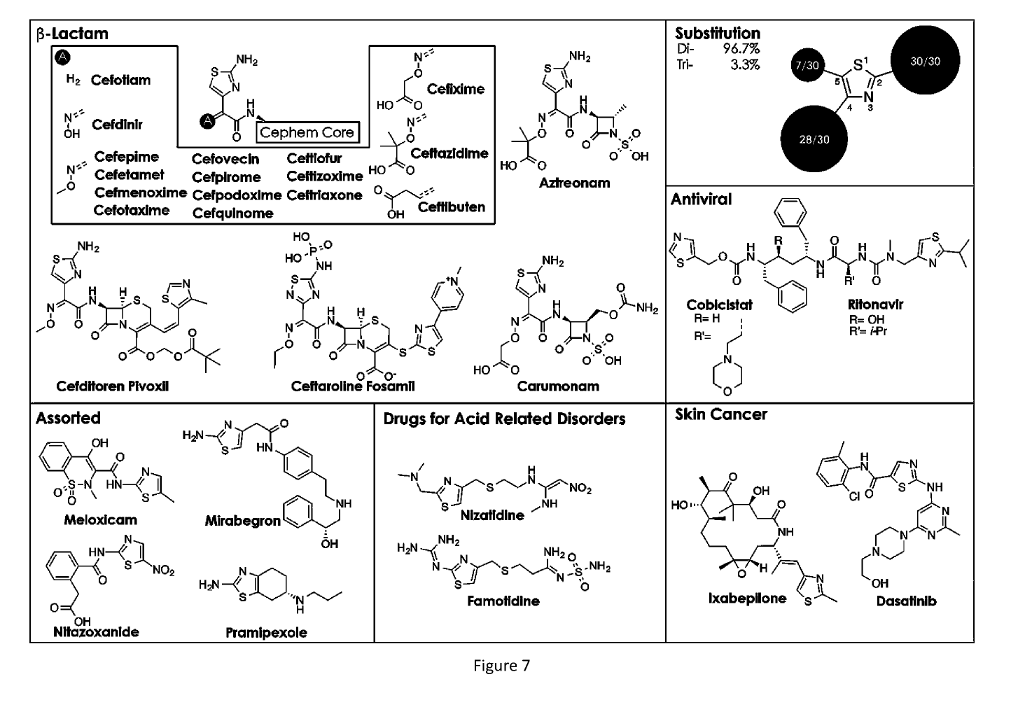

In analyzing the structures of unique US FDA approved drugs containing a thiazole group, (FIG. 7) it becomes evident that one of the reasons for its high frequency five membered aromatic nitrogen heterocycle is because it has emerged as one of the favorite functional group for the large class of β-lactam antibiotics. Remarkably, 67% of all thiazole containing pharmaceuticals belong to this important class of drugs. Interestingly, every single one of the thiazole drugs contain a substituent in the 2-position, with most also being decorated with an additional substituent at the 4-position. Not a single approved drug contains a mono-substituted thiazole group. The anti-HIV drugs ritonavir and cobicistat are noteworthy for not only for their structural similarity but for also having two different thiazole groups along with cefditoren pivoxil as part of their structure. Pramipexole is the only drug containing a tri-subsituted thiazole group. Ixabepilone, which is a lactam derivative of epothilone B, is the only approved drug emerging to date from this interesting family of natural products. The peptic ulcer disease drugs nizatidine and famotidine are structurally intriguing for also containing thioethers and interesting nitro and sulfonamide groups.

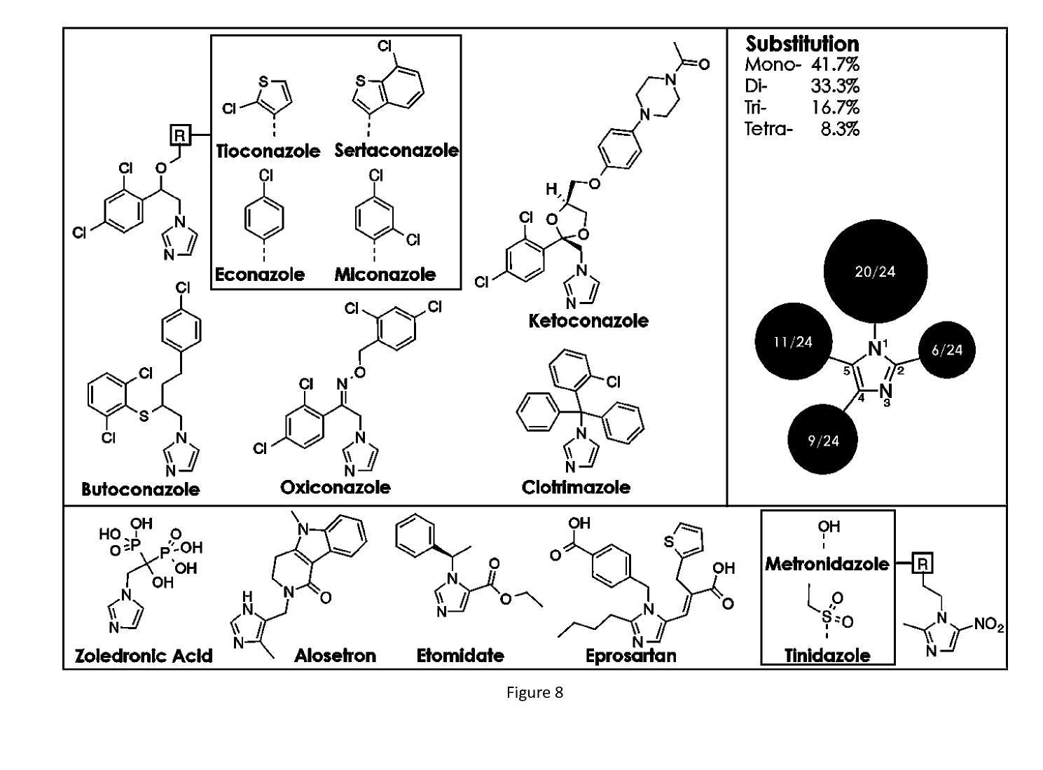

Imidazoles, a selection of which are displayed in FIG. 8, are the second most common aromatic five membered nitrogen heterocycle among unique US FDA approved pharmaceuticals. Of these twenty four imidazole containing structures, eight (33%) belong to a class of antifungal agents, all of which share a similar substitution patterns, such as the presence of chlorinated aromatic rings and a singularly substituted imidazole group. All chiral center containing structures of this antifungal class are sold in racemic form except ketoconazole. The antibacterial drugs metronidazole and tinidazole are notable for their small size and the presence of a nitro substituent on the imidazole ring. Additional examples of noteworthy imidazole drugs are also shown in FIG. 8. Analysis of imidazole drug substitution patterns reveals that 42% are mono-substituted, of which all but one are connected via the imidazole nitrogen atom (purple). The remaining imidazole drugs are di- (33%), tri- (17%) or tetra-substituted (8%), with no clear substitution preference among them.

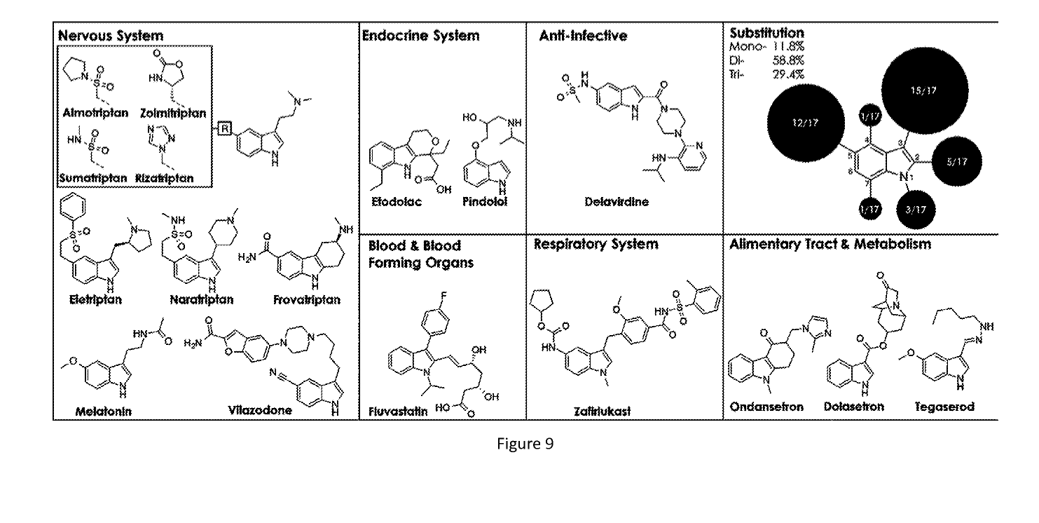

Indole is an important nitrogen heterocycle found in countless natural products, part of an essential amino acid (tryptophan), and a key structural component of many value added chemicals including pharmaceuticals. In the database of unique small molecule US FDA approved drugs, there were 17 indole containing drugs, all of which are shown in FIG. 9, along with their disease indications. The indole core has seven positions that can be substituted. Survey of these 17 structures reveals that two (12%) are mono-substituted, ten (59%) are di-substituted and the rest (5, 29%) are tri-substituted. A closer looks reveals that there are preferred substitution patterns with vast majority of these drugs containing a substituent at C3 (88%, green) and/or C5 (71%, mustard). These strongly favored positions are followed by C2 (29%, orange), N1 (18%, purple), C4 and C7 (6%, red and grey) with no indole drug being substituted at C6. Three (frovatriptan, ondansetron and etodolac) of the seventeen indole drugs are decorated with a fused ring, which in all cases is a six membered ring connected to the indole at C2 and C3. The blood pressure medicine pindolol is particularly interesting as it is one of only two approved indole drugs that are mono-substituted, but more importantly the only one that contains a substituent at C4. The largest drug class containing indoles in the form of a triptamine core are analgesic's (41%).

Benzimidazoles are found in thirteen US FDA approved pharmaceuticals. Five of those drugs are structurally similar proton pump inhibitors, all of which contain a sulfoxide group with a pyridine side-chain in the 2-position. Interestingly, one of these (esomeprazole) is a single enantiomer sulfoxide variant of the best known member of this family (omeprazole). Three of the benzimidazole drugs are used to treat hypertension (candesartan, telmisartan and azilsartan medoxomil). Candesartan and the prodrug azilsartan medoxomil are near identical structures differing only in the nitrogen heterocycle attached to the biphenyl group while telmisartan is the only drug that contains two benzimidazole groups. All of these drugs contain a substituent at the benzimidazole 2-position, which in majority of cases (77%) is a heteroatom (O, S or N). The second most commonly substituted position is the benzimidazole 1-position (46%).

The distribution among the top five most commonly employed non-aromatic five membered nitrogen heterocycles in pharmaceuticals is less even than among the aromatic ones. One group, pyrrolidine, is most abundant in this category, with appearances in 37 drugs. The next three heterocycles (imidazolidine, imidazoline and oxazolidine) in the top five are not only about equally represented but also contain two heteroatoms separated by a carbon atom. Rounding of the top five is indoline. Given the success of pyrrolidine we take a closer look in the following section at the structures of pharmaceuticals containing this important heterocycle.

In the category of US FDA approved drugs containing 5-membered non-aromatic nitrogen heterocycles, pyrrolidine is represented in more drugs than the rest of the top five combined. Most of the pyrrolidine drugs contain an N-substituent (92%, purple), with the pyrrolidine 2-position (orange) being substituted in 62% of cases followed by about equal chance of substitution at the 3- (green) and 4-positions (red) and only a 16% likelihood that the 5-position (mustard) is substituted. For pyrrolidines, di-substitution is the most dominant pattern (41%), followed by equal 19% representation of mono-, tri- and tetra-substituted pyrrolidine drugs. The natural proline core is a commonly employed pyrrolidine structural fragment. This chiral fragment is the core of most of the angiotensin converting enzyme (ACE) inhibitors. All of these inhibitors additionally contain a chiral amide chain, of which half have a chiral phenethyl substituted α-amino ester. Of the other drugs highlighted, both clindamycin and remoxipride contain a proline type core. Clindamycin and lincomycin are particularly noteworthy for also having a thiosugar group and a chiral secondary chloride atom in addition to the proline core. Rocuronium is an interesting steroidal drug with two nitrogen heterocycles attached to the A and D rings, of which the pyrrolidine group is in the form of an allyl ammonium salt. Procyclidine is an example of a simple mono-substituted pyrrolidine drug. The antipsychotic medicine, asenapine, is an intriguing example of a 3,4-fused pyrrolidine ring system that at first glance looks C2-symmetrical were it not for the presence of single chlorine atom. The anti-seizure drug ethosuximide is the structurally simplest of all the approved pyrrolidine drugs, being simply a dialkylated N-succinimide derivative.

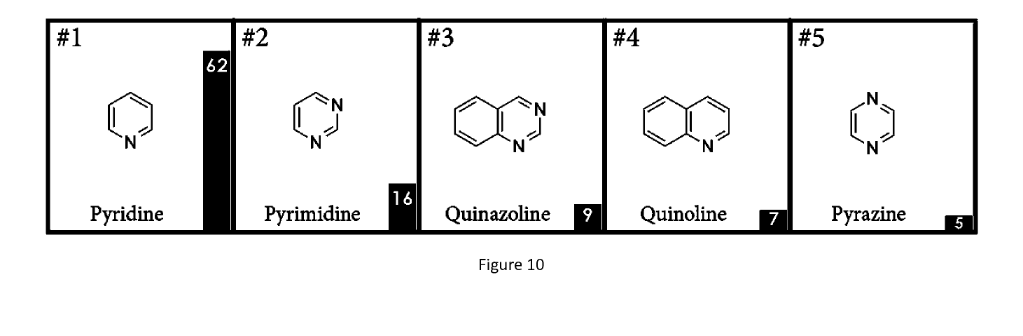

The top five of the most commonly used six membered aromatic nitrogen heterocycles are shown in FIG. 10. These five appear in 99 drugs, which is 9% of the total number of unique structures among US FDA approved pharmaceuticals. More than 60% of the structures represented by these top five contain a pyridine, with second place pyrimidine appearing in 16%. Three of the five heterocycles in this category contain an additional heteroatom, which in all cases is a nitrogen atom (pyrimidine, quinazoline and pyrazine). Given these different structure distributions, in the following two sections we will focus our in depth analysis and discussion only on pyridine and pyrimidine.

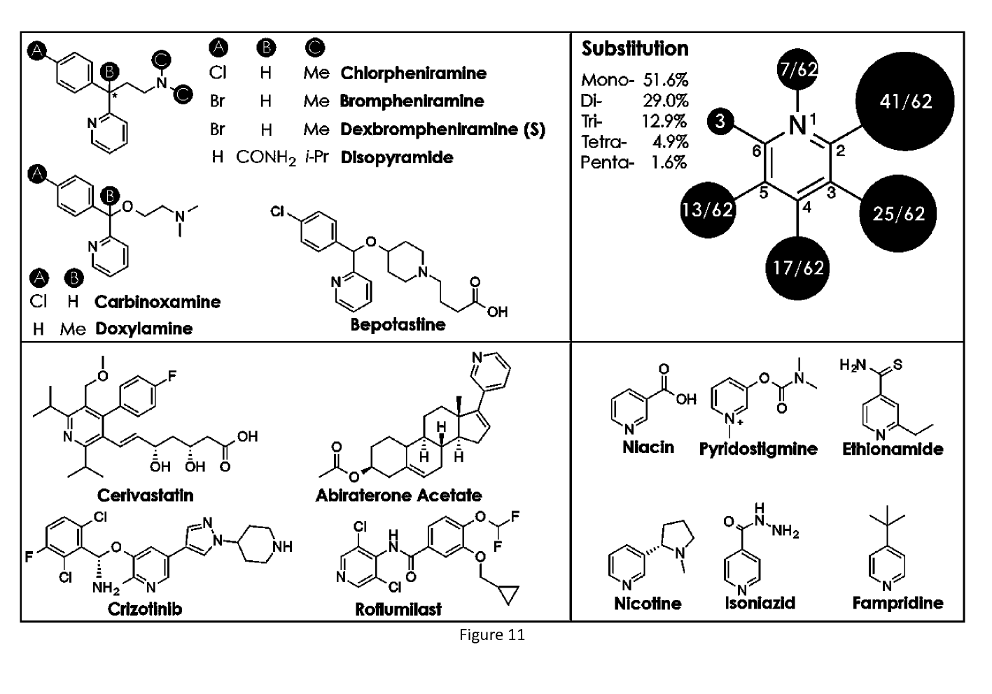

Pyridine is the second most commonly used nitrogen heterocycle among all US FDA approved pharmaceuticals, and number one among aromatics. Analysis of the substitution patterns for these sixty-two pyridine drugs is presented in FIG. 11. Data analysis revealed that the pyridine 2-position (orange) is preferred followed by the 3-position (green) with 66% and 40% of such drugs substituted at any of those positions, respectively. A closer look at these substitution patterns reveals that mono-substituted pyridines are found in more than 50% of these drugs followed by di- and tri-substituted ones with 29% and 13% representation, respectively. A family of antihistamine drugs with a remarkably similar structural core, of which all contain a pyridine substituted in the 2-position with a benzylic group decorated with a trialkylamine chain, was further analyzed. The oldest of these drugs are chlorpheniramine, brompheniramine and its enantiomer dexbromopheniramine, all of which were approved by the US FDA in the 1950's. Carbinoxamine and doxylamine are strikingly similar structures differing from the other three by the addition of an oxygen atom in the trialkylamine tether and in the case of doxylamine also by a quaternary benzylic center. Bepotastine is the most recently approved member of this family. It contains a longer and more rigid side chain, as well as a carboxylic acid tail. Disopyramide, does not belong to the antihistamine class, but is included because of its remarkable structural homology with members of this class. Pyridine is also unique among nitrogen heterocycle containing drugs for how many of these drugs are basically pyridines with one small substituent. Six of these unique small molecule drugs (nicacin, pyridostigmine, ethionamide, nicotine, isoniazid and fampridine) are shown in FIG. 11. Four additional interesting pyridine drugs were chosen for further analysis, of which three are fluorinated, three were approved in 2011 (roflumilast, abiraterone acetate and crizotinib), and two originate from natural product cores. Cervistatin, which was withdrawn in 2001, is one of only three drugs that have penta-substituted pyridine cores. Roflumilast has in addition to a dichlorinated pyridine core, intriguing difluoroether and cyclopropylmethanol substitutents attached to a catechol group. The prostate cancer drug, abiraterone acetate, is a prodrug that loses an acetate group in vivo to form abiraterone. Abiraterone is easily synthesized by converting the ketone of readily available dehydroepiandrosterone (DHEA) to a vinyl pyridine group. Crizotinib is also an anti-cancer drug. It is structurally notable for the presence of three nitrogen heterocycles (pyridine, piperidine and pyrazole) with a central electron rich tri-substituted pyridine core.

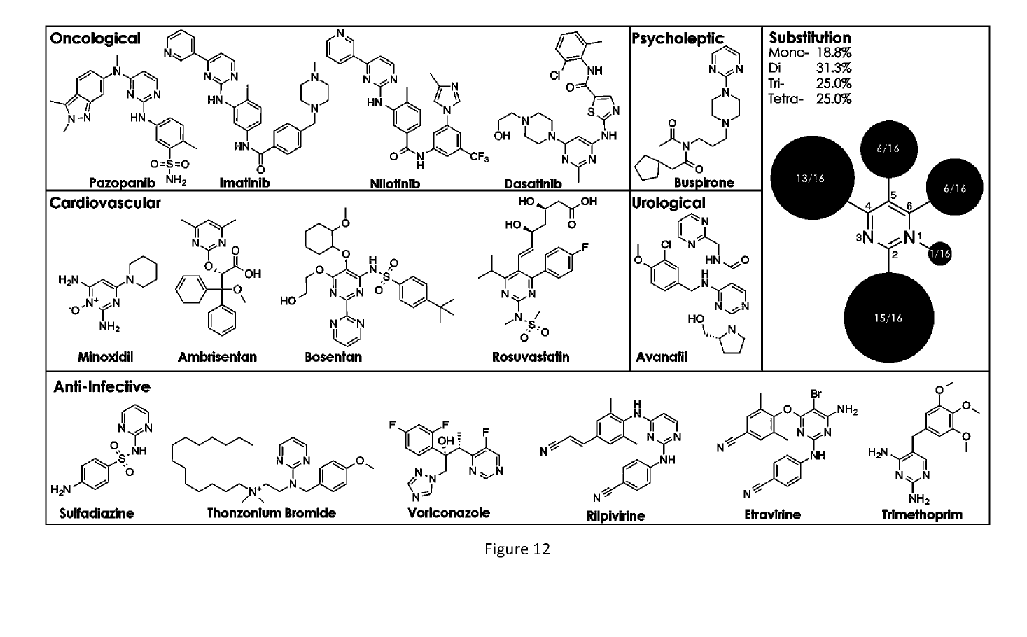

Shown in FIG. 12 are the sixteen approved pyrimidine containing drugs arranged according to how many substituents the pyrimidine core has (mono, di, etc.) and disease indication. The oldest pyrimidine drugs are the anti-infectives sulfadiazine and thonzonium bromide, which were approved by the FDA in 1941 and 1962, respectively. With the exception of the recently approved erectile dysfunction medicine, avanafil (2012), and the general anxiety disorder drug, buspirone, the other pyrimidine drugs are used for the treatment of three (anti-infective, cardiovascular and oncological) main disease classes. The oncological drug imatinib, which was approved in 2001, is particularly noteworthy as a breakthrough rationally designed drug. Many other tyrosine kinase inhibitors like imatinib have since been approved as oncological drugs, including three containing a pyrimidine group (dasatinib, pazopanib and nilotinib). Rosuvastatin, the top selling pyrimidine drug, with multibillion dollars sales per year, is a member of the statin family. Pyrimidine substitution pattern analysis revealed that the 2-(orange) and 4-positions (green) are strongly favored, with 94% and 81% of drugs in this class containing substituents at these positions, respectively. There is close to an even distribution of mono-, di-, tri- and tetra-substituted pyrimidines. Almost all pyrimidine drugs contain a nitrogen substituent (88%) of which 38% are a 2-amino group and another 38% are 2,4-diamino groups. The HIV-drugs rilpivirine and etravirine are particularly noteworthy for containing two nitrile groups. Many of the pyrimidine drugs contain multiple rings linearly connected together. Minoxidine and etravirine are structurally remarkable for the fact that not only is the pyrimidine core tetra-substituted, but all of the substitutents are heteroatoms.

The family of non-aromatic six membered nitrogen heterocycles is remarkably represented by three rings in the top 10, which include the number one (piperidine), and three (piperazine) categories. Even more impressively, the top five in this category appear cumulatively in a little over a quarter (27%) of all drugs containing a nitrogen heterocycle. Three of the five contain two heteroatoms in the ring, which in all cases is in the 4-position (O, S or N) with respect to the common nitrogen atom. In the following sections, further analysis of the three most frequent of those five, namely piperidine, piperazine and phenothiazine containing drugs, is presented.

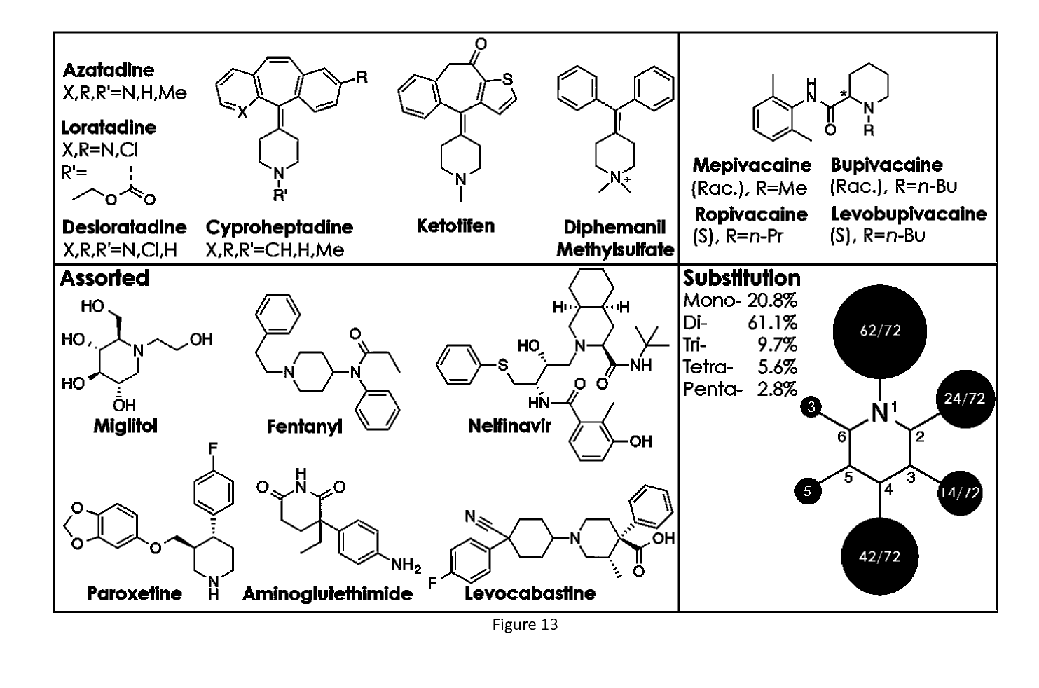

Piperidine is at the top of the list of most commonly used nitrogen heterocycles among US FDA approved pharmaceuticals. Shown in FIG. 13 are two important piperidine containing drug classes, a selection of interesting piperidine drugs, and analysis of the positions of preferred piperidine substituents. It is evident from this graphic that the N1- and 4-positions are strongly favored with drugs in this class having, 86% or 58%, likelihood, respectively of containing a substituent in those positions. The 2- and 3-positions follow with 33% and 19% representation, and only a handful of drugs having a substituent in the 5- and 6-positions. Taking closer look at these substitution patterns reveals that unlike its aromatic counterpart, for which mono-substituted drugs are most common, piperidine drugs are much more likely to be di-substituted (61%) vs. mono-substituted (21%). Within this di-substituted group of piperidine drugs there is a strong bias towards 1,4-disubstituted (39%) architectures. Piperidines feature prominently in an antihistamine class of drugs (azatadine, loratadine, desloratadine, cyproheptadine and ketotifen), all of which contain an exo-tetrasubstituted olefin at the 4-position connected to a fused tricyclic system with a central seven membered ring. Strikingly similar, while lacking the central fused ring, is the antimuscarinic agent diphemanil methylsulfate. Mepivacaine, bupivacaine, ropivacaine and levobupivacaine are all local anaesthetic drugs that share a common piperidine core with an ortho-xylene amide in the 2-position, and only differing in the length of the N-alkyl group chain. Interestingly, levobupivacaine is a single enantiomer of racemic bupivacaine. Finally, six structurally and medicinally intriguing piperidine containing drugs are shown. Miglitol is an interesting desoxy aminosugar. Fentanyl, which is a powerful analgesic, serves as nice representative example of a 1,4-disubstituted piperidine drug, which is the most commonly employed substitution pattern. Nelfinavir is an antiviral agent containing a tetra-substituted piperidine that is part of a fused core and connected to an interesting sidechain containing two chiral centers, a thioether and a phenol group. The billion dollar antidepressant, paroxetine, contains two stereocenters on the pyridine ring. The anti-hormone drug aminoglutethimide is a glutarimide with ethyl and aniline groups in the α-position. The anti-allergic drug levocabastine is an interesting structure with four rings connected linearly, of which two of the junctions are quaternary and one is chiral. The piperidine is decorated with four substituents including a carboxylic acid, while the distant fluorophenyl group is connected to a tertiary nitrile.

Piperazine is an important nitrogen heterocycle that has been shown to be essential structural component for three families of pharmaceuticals, of which 32% of approved piperazine drugs belong. The largest of these, with ten approved structures, is the fluoroquinolone family of antibiotics, followed by a group of antihistamine drugs containing cyclizine cores, and the homologous blood pressure medications, prazosin, terazosin, and doxazosin. Analysis of piperazine substitution pattern reveals a lack of structural diversity, with almost every single drug in this category (83%) containing a substituent at both the nitrogen 1- and 4-positions and only a handful having substituent (methyl or C═O) at any of the four carbon atoms (2, 3, 5 and 6).

The third most commonly used six-membered non-aromatic nitrogen heterocycle is phenothiazine with sixteen unique small molecules approved. Phenothiazine is a linearly fused tricyclic architecture that could also be described as a thiomorpholine core with two fused benzo groups. What is striking about phenothiazine drugs is their high degree of structural and disease function homology, placing it in its own class among significant nitrogen heterocycles. Analysis of the database showed that these drugs are all substituted at only two positions, namely the nitrogen atom, and the 2-position, which is meta to the nitrogen atom. The aryl 2-position is either not substituted or contains a small polar group (R′═Cl, CF₃, SEt, SMe, SCOMe, COEt or COMe) while the phenothiazine nitrogen atom is in all cases connected to a short alkyl tether with a trialkylamine group either three or four atoms away. The trialkylamine moiety is either part of another nitrogen heterocycle (63%) or part of a chain (37%). Majority of these side-chain rings are piperazines (60%), with two piperidines (20%) as well as one pyrrolidine (10%) and one quinuclidine (10%). The alkyl tether from the phenothiazine nitrogen is linearly connected to the trialkylamine nitrogen in majority of cases (75%). Not only are these sixteen phenothiazines structurally remarkably similar, but they all belong to the same psycholeptic drug class (the “azines”) first introduced in the 1950's, where over a four year period (1956-1959) seven (44%) of the sixteen members of this class were approved. The last member to be approved in this class of pharmaceuticals was triflupromazine in 1983.

Although certainly less common than their 5- and 6-membered ring counterparts, seven and eight membered nitrogen heterocycles are important pharmaceutical core fragments. Not surprisingly the famous benzodiazepine core is at the top, followed by several reduced and fused azepine variants.

The two most significant seven membered nitrogen heterocyclic cores based on the database analysis are benzodiazepine and azepine. The eight benzodiazepine drugs are remarkably similar, differing in the nature of the substituent at only four positions. Most of the other substitution variations are small, representing simple atom (halogen, H) or small group (methyl, OH, NO₂) variations. The bis-aryl fused azepine pharmaceutical cores are even more homologous, with substitution patterns being reamarkably similar representing the presence or absence of a methyl group or in a single case aryl C—H or aryl C—Cl (clomipramine).

Analysis also includes a category focused on fused ring systems, which are defined as those nitrogen heterocycles that contain more than one nitrogen heterocycle, although not necessarily directly adjacent to each other. This category included to avoid structures like the ergoline core as belonging both to the indole and piperidine families of heterocycles. The top two members in this category are the natural product architectures purine and ergoline with about equal representation.

All of the purine drugs are either approved as anticancer or antiviral agents. Majority (70%) of the purine containing drugs are nucleosides of which all except abacavir are remarkably similar. The antivirals tenofovir and adefovir are also structurally nearly identical with their purine cores attached at the same position to a short chain terminated by a phosphonic acid group.

Interestingly, the most commonly prescribed fused ring system containing two or more nitrogen heterocycles is a natural product core belonging to the ergot family of alkaloids, of which most members are derivatives of ergotamine. Drugs in this class are used to treat conditions such as dementia, parkinsons and migraines. The anti-parkinson agent lisuride is structurally unique among all these approved ergot alkaloids for having the opposite stereochemistry at the critical C8-stereocenter. Furthermore, lisuride is remarkably similar to lysergic acid diethylamide (LSD) apart for additional nitrogen atom (urea instead of an amide) and the opposite C8-stereochemistry. Interestingly, the pharmaceutical agent ergoloid is a combination of dihydroergocornine, dihydroergocristine, dihydroergocryptine and epicriptine, which differ structurally only in substitution at a single position.

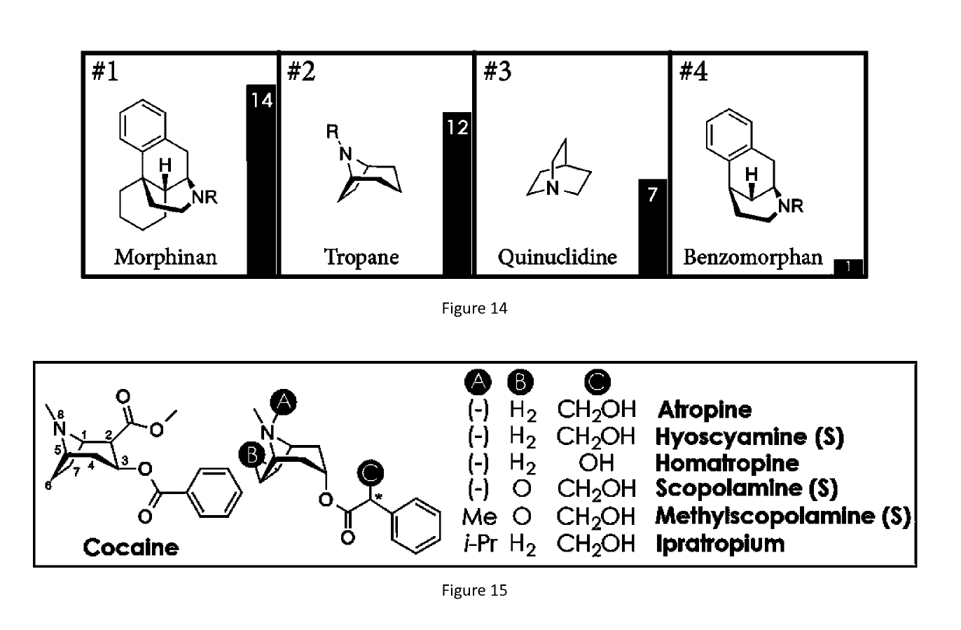

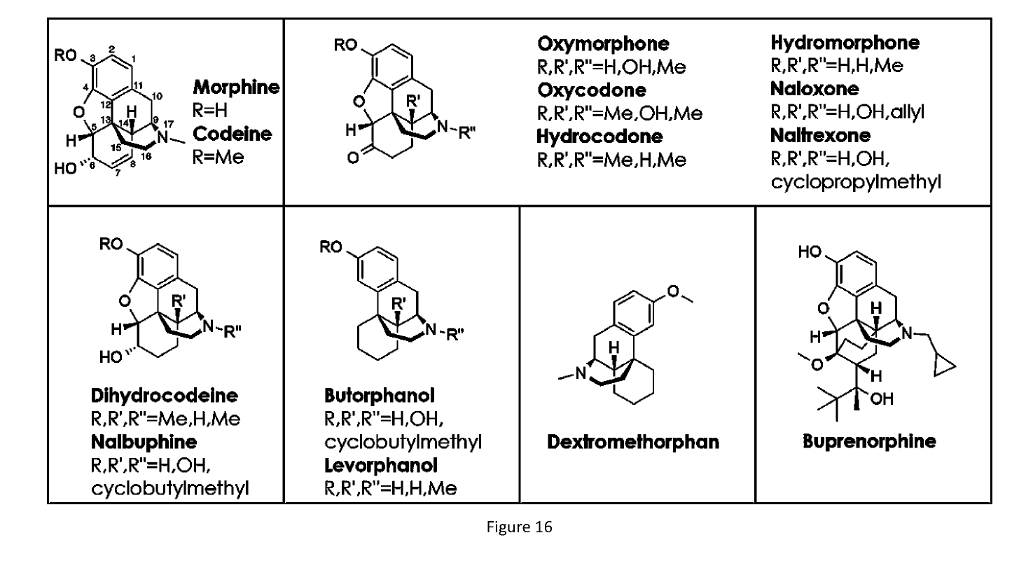

Bridged bicylic nitrogen heterocycles are an important structural class among approved pharmaceuticals. The top four most commonly occurring cores are shown in FIG. 14. All are derived from or inspired by natural products, with the top seat belonging to the tropane family of alkaloids, followed closely by the morphine architecture and quinuclidine representing the third most frequently used core. Cocaine is the most famous of the tropane alkaloids, but almost all of the US FDA approved drugs containing the tropane core are symmetrical and lack the carboxylate group found in cocaine. The family of pharmaceuticals represented by the morphinan core is old and important, with morphine, oxycodone, hydromorphone and codeine as its most famous members.

Top among bridged bicyclic nitrogen containing US FDA approved heterocycles is the [3.2.1] bridged bicyclic tropane core (FIG. 15). Natural products are the reason for the existence of this important class of drugs as atropine, hyoscyamine, scopolamine and cocaine are all natural products with other members being derivatives. For example, homatropine has one less methylene group than atropine while methylscopolamine and ipratropium are alkyl ammonium salts of scopolamine and atropine, respectively.

A closer look at the morphinan core substitution patterns variations are displayed in FIG. 15. Morphine and codeine, which only differ in methylation at the C3-phenol group, are the only drugs in this group that contain a C6-C7 double bond. Most of the other morphinans, represented by dihydrocodeine and oxycodone, only deviate in their subtle substitution differences at C6, C14, N16 and the C3 phenol. The changes at the C3 phenol or C14 involve only absence of presence of a methyl or hydroxyl group, respectively, while the N16 modifications involve permutations of short alkyl chains. Dextromethorphan and butorphanol are the most reduced members of this class with both lacking the furan heterocycle as well as any C6 oxygenation while buprenorphine is the most complex one, with additional sidechain at C7 and an intriguing bridging carbon chain between C16 and C6. Morphinan drugs are common components of combination drug therapies.

Quinuclidine is an interesting [2.2.2]-bridged bicyclic nitrogen heterocycle with a single nitrogen atom located at the bridgehead. The natural products quinine and quinidine are without a doubt the most famous members of the quinuclidine family, with a long history in folk medicine, as pharmaceuticals, and in recent decades as privileged chiral organic ligands in catalysis. Dolasetron and palonasetron, despite being drastically dissimilar with respect to their quinuclidine substituents, both are prescribed for the treatment of vomiting and nausea associated with chemotherapy. Interestingly, all of the approved quinuclidine drug cores are decorated with heterocycles, which with the exception of aclidinium, is a nitrogen heterocycle (quinolones, phenothiazine, indole and isoquinolones). Aclidinium, used for the treatment of chronic obstructive pulmonary disease (COPD), is the most recently approved (2012) of these pharmaceuticals.

Macrocyclic nitrogen heterocycles are critical parts of important pharmaceuticals of which the family of immunosuppressive agents derived from the natural products rapamycin (sirolimus) and FK-506 (tacrolimus) are most significant. Among approved nitrogen macrocycles almost all are natural products or derivatives of natural products. In addition to rapamycin and FK-506, these include the antibiotics azithromycin, which is a simple derivative of erythromycin, and rifaximin, which is derived from rifamycin. Plerixafor is fascinating symmetrical structure with two sixteen membered tetraaza-crown groups connected to a central para-xylyl group. The epothilone derivative ixabepilone is a macrolactam whose only structural deviation from the natural product (epothilone B) it originated from is the lactam nitrogen.

There is one structurally intriguing nitrogen heterocycle that also contains a metal atom. This nitrogenous metallocycle is oxaliplatin, which was approved in 2002, and belongs to a small but successful family of platinum containing oncological drugs of which cisplatin was first approved (1978). In all cases, the platinum atom is connected to four groups of which two are always amines, with the other two being chloride atoms or a carboxylate group.

This perspective presents the first detailed analysis of the nitrogen heterocyclic composition of US FDA approved unique small molecule pharmaceuticals. The fact that 59% of small molecule drugs contain a nitrogen heterocycle firmly ranks them as the most privileged and significant structures among pharmaceuticals. This analysis was made possible for pharmaceutical non-experts by the recent creation and publication of our disease focused pharmaceutical posters. Analysis presented herein reveals the relative frequency by which the various nitrogen heterocycles have in being incorporated into approved drug architectures, wherein the top three spots were ruled by piperidine, pyridine and piperazine. Rounding of the top five where cephem and pyrrolidine rings. The analyses of databases showed just how impactful only a handful of nitrogen heterocycles have been. Within each heterocyclic sub-category we chose to reveal any interesting common structural patterns that these nitrogen heterocycles were part. Any apparent substitution pattern biases or lack thereof we chose to present as well. It is quite amazing to look over the schemes in this perspective and by amazed by the many successful, but structurally near identical, frameworks that have been used for countless drugs. Most notable of the structurally similar drugs are the ones containing cephem, penam, piperazine, phenothiazines or morphinan cores. With respect to nitrogen heterocyclic substitution diversity or lack thereof among US FDA pharmaceuticals it is quite interesting to review the substitution pattern analyses for the most commonly used nitrogen heterocycles.

This section illustrates methods and systems of the invention in reference to analyzing and/or evaluating a database of FDA approved drugs comprising sulfur and fluorine atoms. However, it should be appreciated that the scope of the invention is not limited to this particular database. The concept and the procedures disclosed herein can be used to analyze and/or evaluate any database to discover or identify lead or drug candidates for a wide variety of clinical indications and chemical compounds. Accordingly, the scope of the invention encompasses evaluation and/or analysis of any set of database for use in discovery and/or identification of drugs or lead candidates for drugs.

Among carbon, hydrogen, oxygen, and nitrogen, sulfur and fluorine are both leading constituents of the pharmaceuticals that have been approved by the FDA. Statistics were collected from the trends associated with therapeutics spanning 12 disease categories (a total of 1969 drugs). From this compilation, various categories of data were collected, such as structural image, FDA approval date, international nonproprietary name (INN), initial market name, a color-coded sub-class of function, or a combination thereof. In some embodiments, the database was organized chronologically and classified according to an association with a particular clinical indication. In one specific embodiment, the evolution and structural diversity of sulfur and the popular integration of fluorine into drugs introduced over the past fifty years was evaluated.

Database based on the drugs approved by FDA through 2011, consisted of 1969 compounds. It should be appreciated that the database can be upgraded continuously, e.g., by adding newly approved drugs annually.

In one embodiment of the invention, database consisted of all therapeutics grouped according to an association with 12 disease categories (Anti-Infective, Cardiovascular, Alimentary Tract and Metabolism, Musculo-Skeletal System, Oncological, Blood and Blood Forming Organs, Endocrine System, Respiratory System, Dermatological, Nervous System, Sensory Organ, and Genito-Urinary and Sex Hormone). Each pharmaceutical (i.e., drug) is represented by its structure, initial market name, INN, color-coded sub-class of function, and the initial date approved by the FDA. The spartan descriptions enable a user of the database to obtain information about organic architecture and utility. Typically, the database is made dynamic, i.e., it continuously grows or increases as new drugs are approved annually. Thus, the database is continuously updated or evolved. In some embodiments, uniquely themed subset of database is produced based upon drug similarities, parallels, or patterns contained within this library of pharmaceuticals.

Analysis of database below provides another example of identifying a lead drug candidate. Of the principal elements that comprise all drugs: carbon, hydrogen, oxygen, or nitrogen, sulfur represents the fifth most prevalent element in overall architectural representation and biological significance. Sulfur compounds are in clinical use for various medical conditions, such as depression, arthritis, diabetes, cancer, and Acquired Immune Deficiency Syndrome (AIDS). Moreover, fluorine, the smallest halogen and most electronegative element, is present in about 20% of recently approved pharmaceuticals.

In this particular embodiment, the database was analyzed to determine statistics associated with the incidence of sulfur and fluorine in the molecular composition of small-molecule and combination drugs. Following an initial tabulation of the sulfur-containing and fluorinated pharmaceuticals in both of the Top 200 Brand Name Drugs by US Retail Sales in 2011 and Top 200 Brand Name Drugs by Total US Prescriptions in 2011, the overall diversity and evolution of sulfur and fluorine in pharmaceuticals over time were then evaluated.

The use of organosulfur compounds as medicinal remedies dates back to the ancient Egyptians, who described a sulfuric ointment with mild antiseptic effects. Similarly, the mythological writings of the ancient Greeks depicted injured warriors healing in the sulfur-rich Baths of Agamemnon. During the Victorian era in Europe, people often used ‘brimstone and treacle’ as a laxative and tonic for children. In the 1920's, ‘colloidal’ sulfur was regularly administered to patients suffering from rheumatoid arthritis. Eventually, modern medical applications of sulfur-containing compounds have grown to include antibacterials, anti-inflammatories, dermatologics, and cancer treatments. Considering the age of drug resistance and the continual need for the development of medicinal therapies, existing sulfur-containing compounds can be analyzed to determine new compounds and/or new lead compounds to other pharmaceuticals.

The medicinal impact of organosulfur compounds is extraordinary. Inspection of the structures of compounds within both of the Top 200 Brand Name Drugs by US Retail Sales (RS) in 2011 and Top 200 Brand Name Drugs by Total US Prescriptions (P) in 2011 revealed that 24.8 and 22.5% of drugs (excluding biological drugs) contain this heteroatom. In addition, 40% and 25% of the top 20 drugs by RS and P, respectively, including: Plavix® (Clopidogrel, #2 RS, #7 P, thiophene), NexIUM® (Esomeprazole, #3 RS, #11 P, sulfinyl), Seroquel® (Quetiapine, #6 RS, thiazepine), Singulair® (Montelukast, #7 RS, #8 P, thioether), Crestor® (Rosuvastatin, #8 RS, #10 P, sulfonamide), Cymbalta® (Duloxetine, #9 RS, thiophene), Actos® (Pioglitazone, #13 RS, thiazolidinedione), Zyprexa®, (Olanzapine, #16 RS, thiophene), and Amoxicillin (Amoxicillin, #20 P, β-lactam) contain sulfur.

Noteworthy advances in the development of fluorinated drugs as anesthetics, blood substitutes, antivirals, antifungals, fluorinated steroids, anti-inflammatories, central nervous system (CNS) medications, and anti-cancer therapies have been accomplished within the past ten years. However, to date, the representation of fluorine is markedly less, existing in only 15% of the top 20 drugs, particularly, as a fluorinated aromatic: Lipitor® (Atorvastatin, #1 RS, #5 P), Crestor® (#8 RS, #10 P), and Lexapro® (Escitalopram, #18 RS, #16 P). The percentage of sulfur-containing drugs exceeds fluorinated compounds in both surveys.

Historically, small-molecule compounds range in architectures from simple organic acyclics and heterocyclics to complex peptides, carbohydrates, and natural products. However, the first biological drug, a biosynthetic ‘human’ insulin trade-named Humulin, was developed by Genentech and manufactured/marketed by Eli Lilly and Company. Since its approval for therapeutic use in 1982, the majority of biopharmaceutical products derived from natural sources have grown to include proteins, nucleic acids (deoxyribonucleic acid (DNA), ribonucleic acid (RNA) or antisense oligonucleotides) and living microorganisms (viruses and bacteria). Biologics, such as synthetic insulin analogues, encompass a considerable percentage of drugs for the treatment of conditions dealing with blood & blood forming organs. Indeed, the 146 representative biologics (out of 1969 drugs) featured in the database provide a significant medicinal impact within other disease therapies including rheumatology, oncology, cardiology, dermatology, gastroenterology, and neurology. Although many contain sulfur, primarily in the form of disulfides and amino acids, the focus of the following analysis concerns the range of sulfur motifs within small-molecule (e.g., non-peptide or non-oligonucleotide) and combination drugs that have been introduced since the early 1900s.

The frequency of new fluorinated drugs has been gradually rising since their first appearance in the 1950s. However, sulfur continues to maintain its status as the dominating heteroatom integrated into the set of 362 sulfur-containing FDA approved drugs (besides oxygen or nitrogen) through the present. Generally, advantages to the carbon-fluorine bond include its metabolic stability and the fact that fluorine acts as a bioisostere of the hydrogen atom. The incorporation of fluorine generally increases a molecule's lipophilicity, facilitating bioavailability (as in, minimizing the potential cytochrome P450 enzymatic oxidation of proximate functionalities), which in turn maximizes medicinal benefits at a lower dosage. However, there is also a subset of molecules where the introduction of fluorine can actually increase the hydrophilicity of molecules, in which many of these had a fluorine atom within 3 Å of an O atom. Currently, over 225 fluorinated small-molecule and combination pharmaceuticals have been FDA approved exhibiting widespread biological activity since 1955. The rise of fluorinated agents may be on the horizon; nevertheless, sulfur continues to sustain its status as a leading biologically relevant structural component. The structural constraints of fluorine, as in the limitations associated with valency, severely limits the development of varied drug candidates.

Of the 12 disease categories surveyed, sulfur is more heavily represented, prevailing in 10/12 groups, and comprises >50% more drugs than fluorine in Anti-Infective, and >60% in Cardiovascular and Musculo-Skeletal. While sulfur clearly has the advantage to form more structurally diverse bonds, fluorinated compounds surpass organosulfurs by nearly 30% for Sensory Organ therapies. Perhaps this dominance can be attributed to the evolution of analogs of synthetic fluorinated steroids, corticosteroids and prostanoids derived from their C—H precursors developed as extremely potent ophthalmological and otological agents used to treat a variety of diseases. Still, the same fluorinated scaffold has been established for dermatological treatments; which is conceivably a factor that contributes to the equal distribution of both sulfur and fluorine in this category. However, studies have confirmed the development of many adverse effects of inhaled corticosteroids or applying fluorinated therapies to the face, including glaucoma. Therefore, even though a drug scaffold may seem to recur throughout history, evidence of unfavorable side effects reflects the continual need for skeletal improvement. Although it appears that the distribution of sulfur and fluorine is comparable in a few categories, the global range of structure and function of sulfur compounds is far superior.

Elemental sulfur is non-toxic and essential for life. The human body consists of nearly 0.25% of sulfur, which is a crucial component of many biological processes. As a third row element with the capacity to expand its valence shell to form more than four covalent bonds and assume oxidation states ranging from −2 to +6; sulfur can form a variety of molecular arrangements, making it one of the most chemically versatile of the early elements. A survey of the structures in our data set determined that the architectures of sulfur-containing drugs can be classified into 10 different categories of various permutations of organosulfur derivatives including: Sulfonamide, Sulfone, Sulfinyl, Thioester, Thioether, Thiophene, Thiazole, β-lactam, Thiazepine/Thiazine and Thiadiazole. Drugs consisting of minimally represented structural components were characterized according to two additional functional group classes, Miscellaneous-Acyclic and Miscellaneous-Cyclic. Not surprisingly, over 10% of all compounds contain more than one, or more than one type, of the listed functionalities. Contrarily, fluorine is chemically restricted to bonding predominantly with carbon, so the multiplicity of compounds that can be generated is somewhat restricted.

The impact of the development of sulfur therapeutics was instrumental to the evolution of the pharmaceutical industry. Undoubtedly, several valuable lessons have been learned from both the successes and failures of pioneering drugs, as well as from the paths leading to their production. Analysis of the database showed the recurrence of a specific functional group in the set of sulfur-containing drugs. Notably, over 25% of compounds contain a sulfonamide substituent, present nearly 29% of the time. ‘Sulfa drugs’, or synthetic substances derived from sulfanilamide (para-aminobenzenesulfonamide), emerged as effective treatments for bacterial infections and diabetes through the 1940s. In 1932, Gerhard J. P. Domagk discovered that a pro-drug derived from sulfanilamide, trade-named Protonsil, had antagonistic properties against a wide range of bacteria. It was determined that the sulfanilamide portion of the molecule was responsible for this biological effect; acting as a bioisostere of carboxylic acid groups. Sulfanilamide inhibited the action of the physiological substance para-aminobenzoic acid (PABA) (required by bacteria to synthesize folic acid), inspiring the theory for the mechanism of action of drugs that is based on substance antagonism. In the years following, manufacturers continued to produce thousands of sulfa drug analogues, eventually leading to the toxic preparation of ‘elixir sulfanilamide’, a medical disaster that poisoned and killed over 100 people with diethylene glycol, which was the cause of death. This event sparked the passage of the Federal Food, Drug, and Cosmetic Act, which gave authority to the FDA to oversee the safety of drugs and production. Since sulfanilamide, more than 150 different derivatives have appeared on the market, chemically modified to achieve more effective antibacterial activity, wider spectrum of microorganisms affected, or more prolonged action. Sulfonamides also have an extensive biological profile, known to exhibit antibacterial, hypoglycemic, diuretic, anti-carbonic anhydrase, anti-thyroid, anti-inflammatory, anti-hypertensive, anti-convulsant, and anti-cancer properties. These compounds are relatively inexpensive to produce and are still used in many parts of the world to treat fungal diseases in combination with other drugs synergistically. On the other hand, it is no secret that several sulfonamide drug combinations or individual drugs have been said to cause immune mediated allergic reactions. However, reactions such as hypersensitivity or severe skin rashes are now associated with the presence of an aniline structure, and have been incorrectly associated with solely sulfonamide-containing drugs. In some cases, a person can be de-sensitized to these adverse responses using a gradient dosage. Currently, sulfa drugs are receiving renewed interest for the treatment of infections caused by bacteria resistant to other antibiotics.

Penicillins (penams), cephalosporins (cephems), and monobactams constitute the broad class of β-lactam antibiotics, the second most prevalent sulfur scaffold (10.5% representation). In 1929, Alexander Fleming first isolated penicillin from the fungal strain, when he observed that bacterial cultures of Staphylococcus in his laboratory were killed by a mold contaminant, Penicillium notatum. The discovery of penicillin was a breakthrough in modern medicinal chemistry, leading to efficient mass production ($0.55/dose in 1946). In 1944, the determination of penicillin's crystal structure, the β-lactam ring fused to a five-membered thiazolidine ring, by Dorothy Hodgkin paved the way for the development of enhanced antibiotics through structural modification. Today, amoxicillin is still one of the most widely prescribed β-lactam antibiotics since it initially entered the market in 1972. Twenty years later, it was developed into a thriving combination drug treatment for drug-resistant bacteria including clavulanic acid, trade-named Augmentin (approved 1996). Furthermore, cephalosporin analogues containing a β-lactam ring fused to a six-membered dihydrothiazine ring exhibit more potent antibacterial properties. Since the medicinal launch of Cefalotin in 1964, six generations of these agents have been synthesized for clinical use. Monobactams, like aztreonam (Azactam®, approved 1986), are often used in the treatment of meningitis.⁵

Thiazoles and thioethers are equally represented (both 8.8%) as the third most exemplified constituent. Commercially significant thiazoles include many non-steroidal anti-inflammatory drugs (NSAIDs) like the widely prescribed Mobic® (Meloxicam) and are known to exhibit chemotherapeutic effects. Pharmacologically, thioethers are linked to sulfinyls and sulfones by their redox interconversion and exhibit extensive biological activities.

Several underrepresented sulfur-containing moieties have emerged as promising structural components that can be integrated into drugs that have yet to be marketed. In particular, the incorporation of the sulfonamide, RSO₂NHR′, is a strategic approach to designing compounds with limited CNS penetration. Recently, isothioureas and related compounds have been found to be inhibitors of the aspartyl protease beta secretase, which is known to play a role in Alzheimer's disease. The chemically stable sulfoximine functionality retains many favorable medicinal properties but has been significantly overlooked as a feature of potential clinical candidates. In addition, the strongly electron-withdrawing and chemically inert pentafluorosulfanyl (SF₅) substituent possesses a greater lipophilicity than CF₃ and is metabolically stable. Further investigation of such minimally explored discoveries in sulfur (or fluorine) chemistry can only enhance drug design and development.

From a historical perspective, sulfonamides have been a leading constituent in new drugs since the first appearance in the 1930s, occupying six different decades over the last 100 years. Introduced in 1959, hydrochlorothiazide, a sulfonamide-based diuretic is a component of nearly 7% of all small-molecule and combination drugs, has been derivatized into several multi-functional analogs, and remains a successful additive used today. Interestingly, the prominence of β-lactams has declined, while pharmaceuticals containing thiazoles are resurfacing since the 1940s and 1950s. Over the last 30 years, thioethers and thiophenes have also emerged as key functional group substituents.

Evidently, the inclusion of sulfur into new drugs became increasingly popular prior to the 2000s. During the 1990s, sulfur-containing drugs for the treatment of half of the disease categories (Dermatological, Endocrine System, Genito-Urinary & Sex Hormones, Nervous System, Respiratory System, and Sensory Organ) reached an all-time high. Similarly, sulfur-containing Anti-Infectives and Cardiovascular drugs peaked in the 1980s. On the other hand, the frequency of Alimentary Tract & Metabolism and Blood & Blood Forming Organ compounds were greatest in the 2000s. Additionally, sulfur incorporation into Musculo-Skeletal and Oncological products is becoming more common in recent years.

Analysis of the database showed that the overall frequency of sulfur substituent and representation within each disease category is fairly synchronous. Predictably, sulfonamides are a primary structural feature incorporated into 11/12 disease categories, with the only exception being the Respiratory System. They also dominate half of them, in particular, Cardiovascular (75.4%), Sensory Organ (41.7%), Blood and Blood Forming Organ (35.3%), Musculo-Skeletal (34.8%), Alimentary Tract & Metabolism (31.0%), and Endocrine System (28.6%) drugs. Overall, thiophenes are the second most versatile architectural constituent (8/12 categories) although they are lower in occurrence as opposed to thiazoles and thioethers, represented in 5/12 and 4/12 categories, respectively. Thiazepines/Thiazines follow accordingly in quantity and functional capability, most prevalently in Nervous System (31.7%) and Respiratory System (20.0%) compounds. Although the β-lactam is the second most represented moiety in the total number of sulfur-containing pharmaceuticals, it seems that they are most functionally useful as Anti-Infective and Respiratory System drugs. Sulfinyl groups are significant in Alimentary Tract & Metabolism (21.4%) and Musculo-Skeletal (17.4%) drugs, including many that are also Top 200 drugs. Thiadiazoles are most common in Sensory Organ (16.7%) drugs; however, maintain a widespread biological activity profile. The sulfone is an underrepresented functional group, but a therapeutic example exists in 50% of disease categories. The least exemplified functionality, the thioester, is present in the many analogues of Fluticasone, a potent Respiratory System drug. In particular, thioesters are inherently reactive as acylating agents and are potential metabolites of carboxylic acids in vivo which can be converted to acyl-Coenzyme A esters.

Acyclic and cyclic sulfur constituents describe 17.3% of pharmaceuticals. Particularly, sulfonic acid derivatives, for example, the heparin analogs, are in highest frequency within miscellaneous-acyclic group, primarily existing as a constituent in drugs within 10/12 disease categories (excluding Nervous System and Dermatological drugs). In the late 1990s, thiazolidinediones, the most represented of the miscellaneous-cyclic group, were introduced into drugs as components of anti-diabetic agents for Alimentary Tract & Metabolism and Endocrine System treatments.

Upon visual inspection of structural data set, it is no surprise that many functionally and architecturally captivating pharmaceutical agents incorporate a form of sulfur. For example, thiopental, a general anesthetic drug is nearly 80 years old and still in use. In fact, a quick investigation of this compound (using supplementary sources) reveals that it holds a place on The World Health Organization's “Essential Drug List”, a list of the basic medical requirements to establish a fundamental healthcare system. It is intriguing that a small sulfinyl compound like dimethyl sulfoxide (DMSO) (Rimso-50®, approved 1978) has an extensive medicinal utility scope still in use. Interestingly, a rare gold-thiolate complex trade-named Ridaura® (Auranofin) initially entered the market in 1986 to treat rheumatoid arthritis. The dermatological, Altabax® (Retapamulin, approved 2007), was the first drug of a new class of modern antibiotics to be approved for human use since the discovery of its parent-compound pleuromutilin in 1950. Recently, Teflaro® (Ceftaroline, approved 2010) an advanced generation cephalosporin prodrug incorporating several forms of sulfur: isothiazole, β-lactam, thioether, and thiazole in conjunction with a phosphamic acid, oxime, and a pyridine ring; was approved for the treatment of pneumonia and bacterial skin infections.

The database also enables any viewer to observe the evolution of structure and function of drugs over time. For example, antipsychotic treatments of schizophrenia have evolved from Promazine, consisting of a thiazine adduct, into the inclusion of a more complex isothiazole containing motif, Latuda® (Lurasidone). Similarly, the previously popular volatile anesthetic haloethane, has since been replaced by the highly fluorinated Ultane® (Sevoflurane).

In 1959, two pyscholeptic Nervous System compounds, fluphenazine and trifluoperazine were the first approved drugs to incorporate both a form of sulfur and fluorine within their molecular skeletons. Presently, the sulfur-fluorine overlap has expanded to 36 small-molecule and combination pharmaceuticals spanning 10 disease categories (apart from Sensory Organ and Genito-Urinary & Sex Hormones). With the exception of the miscellaneous-acyclic and thiadiazole compounds, all forms of sulfur are represented in conjunction with fluorinated motifs. Although no discernible patterns that reveal functional group compatibility trends between sulfur and fluorine motifs, trifluorinated aromatics exist in the highest frequency in combination with the majority of sulfur moieties. In 2012, Xtandi® (Enzalutamide) was FDA approved for the treatment of castration-resistant prostate cancer, capitalizing on the dual functionality of sulfur (thioamide) and fluorine (fluorinated aromatic) for its biological efficacy.

Considering the overall functional competence of drugs, there is no doubt that sulfur will continue to be a leading constituent of novel pharmaceuticals. From a synthetic chemistry perspective, the number of unearthed opportunities to develop new methodologies using this medicinal anthology as inspiration is both advantageous and imminent.

One particular embodiment of the invention relates to a concise analysis of the presence of sulfur and fluorine within an extensive set of marketed drugs (1969, total) spanning 100+ years of medicinal history. The statistics regarding the percent composition and functional group representation of both elements in reference to decade and disease category reflect just one demonstration of the magnitude of correlations, whether positive or negative, that can be derived from this dataset. The emphasis on minimalism as a part of database design significantly contributed to the overall ease of statistical assembly.

Some of the information in the database include, but are not limited to, the initial market name, INN, function, rank, and sulfur and fluorine functional group presence. Other information that can be included in the database are: FDA approval year, sub-class of function, sulfur and fluorine functional group type, for 1969 pharmaceuticals (FDA approved from the 1900s through 2012) in 12 disease categories. In some instances, the database consists essentially of drugs and are categorized according to 1) small-molecule, combination, and biological drugs, 2) chemical structure (e.g., sulfur and fluorine functional group presence), and 3) sulfur functional group by decade and by disease category.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

What is claimed is:

1. A method for conducting a drug discovery research, said method comprising:
(a) searching a database to identify a lead drug candidate, wherein said step of searching said database comprises:
(i) obtaining a list of drug candidates and relative occurrence of drug candidate hits based on an inquiry parameter;
(ii) obtaining a subset of relative occurrences of one or more of the other parameters of the database; and
(iii) identifying said lead drug candidate based on the analysis of said step (i), (ii) or a combination thereof;
(b) synthesizing a plurality of derivatives of said lead drug candidate;
(c) analyzing a bioactivity of each of said plurality of derivatives of said lead drug candidate; and
(d) identifying a drug candidate based on the analysis of said bioactivity of each of said plurality of drug candidate derivatives,
wherein said database consists essentially of a list of drugs in a searchable data objects, wherein said drug is approved for a clinical use by an agency having an approval authority for using said drug in a mammal, and wherein said searchable data objects consists essentially of:
chemical structure of a drug, wherein said chemical structure comprises a core structure, substituent, a functional group, or a combination thereof; and
clinical indication approved for said drug by said agency.

2. The method of claim 1, wherein said agency is U.S. Food and Drug Administration, World Health Organization (WHO), a European Union Agency having an approval authority for using said drug in a mammal, or a combination thereof.

3. The method of claim 1, wherein said database is generated by
obtaining unprocessed data associated with a chemical compound from said agency;
parsing said unprocessed data into a plurality of data objects based on a categorization associated with each of the data objects;
identifying and associating additional information with at least one of the data objects; and
storing the data objects in entries within a data structure, wherein said data structure is searchable based on one or more of the data objects.

4. The method of claim 3, wherein at least one of said data objects comprises the presence of a nitrogen atom, sulfur atom, fluorine atom, or a combination thereof.

5. The method of claim 3, wherein said step of parsing said unprocessed data comprises identifying heteroatoms in said drug, identifying a presence of a ring system in said drug, a molecular weight of said drug, approved use of clinical conditions for said drug, or a combination thereof.

6. The method of claim 5, wherein said step of identifying heteroatoms in said drug comprises identifying the number of each heteroatoms in said drug.

7. The method of claim 5, wherein said step of identifying the presence of the ring system in said drug comprises identifying a ring size of said drug, identifying a number of ring system in said drug, or a combination thereof.

8. The method of claim 3, wherein said step of storing said data objects comprises standardizing said data objects.

9. A database for identifying a lead drug candidate consisting essentially of:
a list of drugs in a searchable data objects, wherein said drug is approved for a clinical use by an agency having an approval authority for using said drug in a mammal;
a searchable chemical structure object of said drugs, wherein said searchable chemical structure object comprises a core structure, a substituent, a functional group, or a combination thereof; and
a clinical indication approved for said drug by said agency.

10. The database of claim 9, wherein said database is stored remotely.

11. A system for searching for a lead drug candidate, said system comprising:
an input device adapted for allowing a user to enter an inquiry data object;
a database of claim 9; and
a display unit for displaying a search result to said user.

12. The system of claim 11, wherein said database is stored remotely.

13. The system of claim 11, wherein said database is stored locally.
